(19) United States
(12) Patent Application Publication
(10) Pub. No.: US 2026/0296198 A1
(43) Pub. Date: Oct. 1, 2026

(54) CONTROL TERMINAL, CONTROL METHOD, AND CONTROL PROGRAM

(71) Applicant: Faurecia Clarion Electronics Co., Ltd., Saitama-shi (JP)

(72) Inventor: Hiroe USHIO, Saitama (JP)

(21) Appl. No.: 19/630,040

(22) Filed: Mar. 26, 2026

(30) Foreign Application Priority Data
Mar. 28, 2025 (JP) 2025-057187

(51) Int. Cl. B60K 35/29; B60K 35/26

(52) U.S. Cl. CPC B60K 35/29; B60K 35/26

(57) ABSTRACT

A control terminal configured to control sound reproduced by a first terminal in a vehicle. The control terminal may include: an audio transmission unit that transmits to the first terminal, sound to be reproduced by the first terminal; a first determination unit that determines whether the first terminal is capable of outputting sound from a speaker mounted in the vehicle; and a request unit that requests muting of the first terminal in accordance with determination by the first determination unit, wherein if the first terminal is capable of outputting sound from the speaker mounted in the vehicle, the request unit causes sound to be reproduced by the first terminal without requesting muting of the first terminal, and if the first terminal is not capable of outputting sound from the speaker mounted in the vehicle, the request unit requests muting of the first terminal.

### CROSS REFERENCE TO RELATED APPLICATION

This patent application claims the benefit and priority of Japanese Patent Application No. 2025-057187, filed on Mar. 28, 2025, the disclosure of which is incorporated by reference herein in its entirety as part of the present application.

### FIELD

The present invention generally relates to a control terminal, a control method, and a control program.

### BACKGROUND

Conventionally, there is a technology for sharing content between devices. Patent Document 1 (US Publication No. 2013/0243390) states, "Disclosed herein is a content reproduction apparatus including: a reproduction block configured to reproduce video content; a display block configured to display the reproduced video content; a communication block configured to transmit the video content to a portable reproduction apparatus by wireless communication; a speaker block having at least one first speaker located in proximity and at least one second speaker located in the proximity of the portable reproduction apparatus and an audio output control block configured to control a reproduction state of the speaker block. In a state where the video content is displayed on the display block, each of the first speaker and the second speaker reproduces audio content related with the video content. In a content non-share state, the audio output control block controls audio output such that the second speaker does not reproduce audio content related with the video content."

### SUMMARY

When content is shared in a vehicle, the same image may be displayed on an on-board device and a mobile terminal, with each occupant viewing the image that is easiest for them to view. In this case, having both the on-board device and the mobile terminal output sounds may be annoying for the occupants. This is because vehicle occupants sit in fixed positions, and the device suitable for viewing a screen varies depending on the seating position, while on-board speakers can output sound to the entire interior of the vehicle. For this reason, when sharing content within a vehicle, images must be displayed individually while sound output should be managed in a comprehensive manner.

An object of the present application is to improve the convenience of content sharing within a vehicle.

To achieve the object described above, a typical control terminal of the present application is a control terminal configured to control sound reproduced by a first terminal in a vehicle, the control terminal including:

an audio transmission unit that transmits to the first terminal, sound to be reproduced by the first terminal;

a first determination unit that determines whether the first terminal is capable of outputting sound from a speaker mounted in the vehicle; and

a request unit that requests muting of the first terminal in accordance with determination by the first determination unit, wherein if the first terminal is capable of outputting sound from the speaker mounted in the vehicle, the request unit causes sound to be reproduced by the first terminal without requesting muting of the first terminal, and if the first terminal is not capable of outputting sound from the speaker mounted in the vehicle, the request unit requests muting of the first terminal.

According to the present application, convenience of content sharing within a vehicle can be improved.

### DRAWINGS

FIGS. 1A and 1B form a conceptual diagram of a control method according to Embodiment 1;

FIG. 2 is a functional configuration diagram of a member of a shared group;

FIG. 3 is an explanatory diagram of a content sharing operation;

FIG. 4 is an explanatory diagram of sound control while sharing;

FIG. 5 is a sequence diagram illustrating the operation of a terminal while sharing; and

FIG. 6 is a flowchart depicting the processing procedure of a terminal having a synchronous mode.

### DETAILED DESCRIPTION

Next, an embodiment of the present application will be described using drawings.

### Embodiment 1

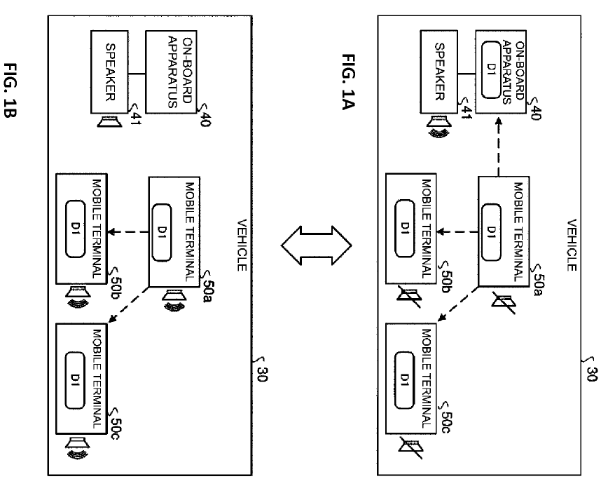

FIGS. 1A and 1B form a conceptual diagram of a control method according to Embodiment 1. A vehicle 30 is equipped with an on-board apparatus 40. A plurality of mobile terminals 50 are installed in the cabin of the vehicle 30. The on-board apparatus 40 is, for example, an information processing device installed in the center of the dashboard or between the driver's seat and the passenger seat. The mobile terminal 50 is a smartphone or tablet carried by an occupant, a display device installed in the vehicle, or the like.

The on-board apparatus 40 is connected to a display that can be seen by the driver's seat and the occupant seat. The on-board apparatus 40 may be configured to include a display. The display may be equipped with a touch panel, and the occupant can input prescribed instructions by contacting the touch panel with a finger or the like. The display may be separate from the touch panel or may be integrated therewith. The on-board apparatus 40 can display map information and route information. The on-board apparatus 40 is connected to a speaker 41 that outputs sound inside the vehicle. The on-board apparatus 40 can play back content such as videos. The on-board apparatus 40 displays the image of the content on a display and outputs the sound of the content through a speaker 41. The on-board apparatus 40 can be a share source that provides content to other terminals, and can also be a share destination that receives content from other terminals.

The mobile terminal 50 includes a display part and a speaker. The display part is, for example, a display. The mobile terminal 50 can play back content such as videos. The mobile terminal 50 displays the image of the content on a display and outputs the sound of the content from a speaker. The mobile terminal 50 can be a share source that provides content to other terminals, and can also be a share destination that receives content provided by other terminals.

In FIGS. 1A and 1B, a mobile terminal 50a serves as a common source to share content. In FIG. 1A, a mobile terminal 50b, the mobile terminal 50c, and the on-board apparatus 40 are the share destinations. The mobile terminal 50a transmits content to the mobile terminal 50b, the mobile terminal 50c, and the on-board apparatus 40. The content to be transmitted includes image and sound data. Since the on-board apparatus 40 is included in the share destination, the mobile terminal 50a transmits mute requests to the mobile terminal 50b and the mobile terminal 50c, and also sets own terminal to mute. As a result, the mobile terminal 50a, mobile terminal 50b, mobile terminal 50c, and the on-board apparatus 40 display the same image "D1", the on-board apparatus 40 outputs sound through the speaker 41, and other terminals do not output sound. Each of the plurality of occupants of the vehicle 30 listens to the sound from the speaker 41 while viewing the image "D1" on a terminal that is easily visible to them.

In FIG. 1B, the mobile terminal 50b and mobile terminal 50c are the share destinations, and the on-board apparatus 40 is not the share destination. The mobile terminal 50a transmits content to the mobile terminal 50b and mobile terminal 50c. The content includes image and sound data. Since the on-board apparatus 40 is not included in the share destination, the mobile terminal 50a does not transmit mute requests to the mobile terminal 50b and the mobile terminal 50c, and also does not set own terminal to mute. As a result, the mobile terminal 50a, mobile terminal 50b, and mobile terminal 50c display the same image "D1" and each output sound. Each of the plurality of occupants of the vehicle 30 views the image "D1" on a terminal that is easily visible to them, while listening to the sound from the speaker 41 of that terminal.

The control method depicted in FIGS. 1A and 1B determines whether a shared group including a content share destination terminal and a content share source terminal as members includes an on-board apparatus 40 that can output sound from an on-board speaker. In the control method depicted in FIGS. 1A and 1B, if the on-board apparatus 40 is included in the shared group, the other members are requested to mute. In the control method depicted in FIGS. 1A and 1B, if the on-board apparatus 40 is not included in the shared group, the other members are not requested to mute.

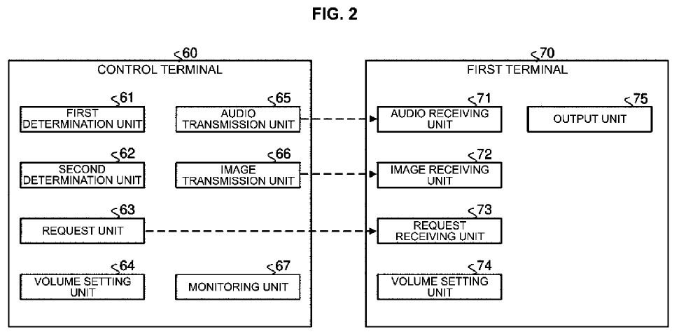

FIG. 2 is a functional configuration diagram of a member of a shared group. A control terminal 60 depicted in FIG. 2 is one of the mobile terminal 50a, mobile terminal 50b, mobile terminal 50c, or the on-board apparatus 40, and is a terminal that is a content share source. A content share source is a terminal that distributes content to terminals other than the control terminal 60. A first terminal 70 depicted in FIG. 2 is any one of the mobile terminal 50a, mobile terminal 50b, mobile terminal 50c, or the on-board apparatus 40, and is a terminal that is a content share destination. The content share destination is a terminal that receives the content distributed by the control terminal 60 and plays back images and sounds via its own display and speaker. There is one control terminal 60 in each shared group. One or more first terminals 70 exist in the shared group.

The control terminal 60 controls the sound reproduced on the first terminal 70 inside the vehicle. The control terminal 60 includes a first determination unit 61, a second determination unit 62, a request unit 63, a volume setting unit 64, an audio transmission unit 65, and an image transmission unit 66. The device may also include a monitoring unit 67, which will be described later. The control terminal 60 has a processor, a memory, and an auxiliary storage device as the physical configuration thereof. The processor of the control terminal 60 reads the control program from the auxiliary storage device, expands the control program into memory, and executes the control program, thereby achieving the functions of a first determination unit 61, the second determination unit 62, the request unit 63, the volume setting unit 64, the audio transmission unit 65, the image transmission unit 66, and the monitoring unit 67.

The first determination unit 61 determines whether the first terminal 70 is capable of outputting sound from the speaker 41 mounted in the vehicle. Being able to output sound from the speaker 41 mounted in the vehicle specifically means that the first terminal 70 can communicate with the speaker 41 via wired or wireless communication and can send sound source data received from the control terminal to the speaker 41. In the present embodiment, for example, the on-board apparatus 40 can communicate with the speaker 41 via wire or wirelessly, and can transmit sound source data received from the control terminal to the speaker 41. Therefore, the first determination unit 61 can determine whether the first terminal 70 is capable of outputting sound from the speaker 41 mounted on the vehicle by determining whether the first terminal 70 is an on-board apparatus.

The second determination unit 62 determines whether the control terminal 60 is capable of outputting sound through the speaker 41 mounted on the vehicle. In the present embodiment, when the control terminal 60 is an on-board apparatus 40, the control terminal 60 determines that sound can be output from the speaker 41 mounted on the vehicle.

The request unit 63 requests the first terminal 70 mute in response to the determination by the first determination unit 61. When the first terminal 70 is capable of outputting sound from the speaker 41 mounted in the vehicle 30, the request unit 63 causes the first terminal 70 to play sound and does not request that the first terminal 70 be muted. When the first terminal 70 is not capable of outputting sound from the speaker 41 mounted in the vehicle 30, the request unit 63 causes the first terminal 70 to mute.

When the control terminal 60 can output sound from the speaker 41 mounted in the vehicle 30 and the first terminal 70 cannot output sound from the speaker 41 mounted in the vehicle 30, the request unit 63 does not request the control terminal 60 to mute but requests the first terminal 70 to mute. When neither the first terminal 70 nor the control terminal 60 can output sound from the speakers mounted in the vehicle 30, the request unit 63 does not request the first terminal 70 or the control terminal 60 to mute.

The volume setting unit 64 sets the volume when the control terminal 60 plays back content. When the control terminal 60 is the on-board apparatus 40, the volume setting unit 64 sets the volume of the speaker 41. When the control terminal 60 is a mobile terminal 50, the volume setting unit 64 sets the volume of the built-in speaker of the mobile terminal 50. The volume setting unit 64 sets the volume to zero when the request unit 63 requests the control terminal 60 to mute. Setting the volume to zero is referred to as setting to mute. When the mute setting is canceled, the volume can be set to the value before setting to mute.

The audio transmission unit 65 transmits to the first terminal 70 the sound to be reproduced on the first terminal 70. The image transmission unit 66 transmits to the first terminal 70 an image to be displayed on the first terminal 70. In other words, the audio transmission unit 65 and the image transmission unit 66 send content including sound and images to the first terminal 70, which is the share destination. The audio transmission unit 65 transmits the sound to be reproduced on the first terminal 70 to the first terminal 70. The image transmission unit 66 transmits the image generated by the control terminal 60 to the first terminal 70.

The first terminal 70 includes an audio receiving unit 71, an image receiving unit 72, a request receiving unit 73, a volume setting unit 74, and an output unit 75. The first terminal 70 has a processor, a memory, and an auxiliary storage device for a physical configuration. The processor of the first terminal 70 reads the control program from the auxiliary storage device, expands the control program into memory, and executes the control program sequentially, thereby achieving the functions of the audio receiving unit 71, the image receiving unit 72, the request receiving unit 73, the volume setting unit 74, and the output unit 75.

The audio receiving unit 71 receives sound of the content from the control terminal 60. The image receiving unit 72 receives the image of the content from the control terminal 60. The request receiving unit 73 receives a mute request from the control terminal 60.

The volume setting unit 74 sets the volume when the first terminal 70 plays back the content. When the first terminal 70 is the on-board apparatus 40, the volume setting unit 74 sets the volume of the speaker 41. When the first terminal 70 is a mobile terminal 50, the volume setting unit 74 sets the volume of the built-in speaker of the mobile terminal 50. The volume setting unit 74 sets the volume to zero when the request receiving unit 73 receives a mute request from the control terminal 60.

The output unit 75 displays the image of the content on a prescribed display part and outputs the sound of the content from a prescribed speaker.

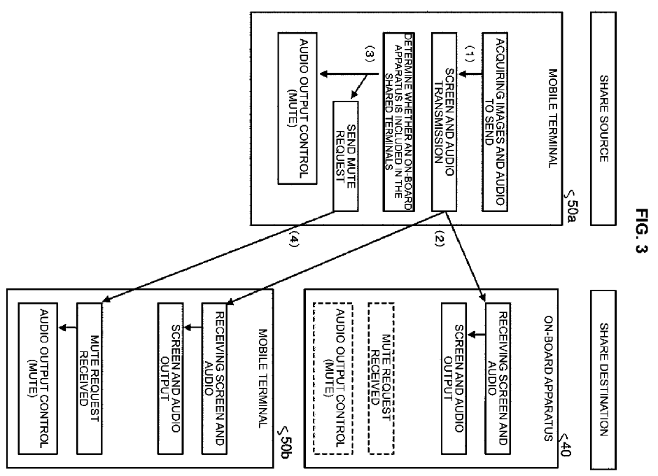

FIG. 3 is an explanatory diagram of the content sharing operation. In FIG. 3, the mobile terminal 50a is the control terminal 60 that is the share source, and the on-board apparatus 40 and the mobile terminal 50b are the first terminals 70 that are the share destination.

The audio transmission unit 65 and the image transmission unit 66 of the mobile terminal 50a acquire the transmission content (1). The audio transmission unit 65 and the image transmission unit 66 transmit the acquired transmission content to the on-board apparatus 40 and the mobile terminal 50b (2).

The audio receiving unit 71 of the on-board apparatus 40 receives the sound of the content from the control terminal 60. The image receiving unit 72 of the on-board apparatus 40 receives the image of the content from the control terminal 60. The output unit 75 of the on-board apparatus 40 displays the received image on a prescribed display and outputs the received sound through the speaker 41.

The audio receiving unit 71 of the mobile terminal 50b receives the sound of the content from the control terminal 60. The image receiving unit 72 of the on-board apparatus 40 receives the image of the content from the control terminal 60. The output unit 75 of the mobile terminal 50b displays the received image on a prescribed display and outputs the received sound from a prescribed speaker.

The first determination unit 61 and the second determination unit 62 of the mobile terminal 50a determine whether the on-board apparatus 40 is in the shared group (3). Specifically, the first determination unit 61 determines whether the share destination terminals include the on-board apparatus 40. The second determination unit 62 determines whether own terminal is the on-board apparatus 40.

If the on-board apparatus 40 is in the shared group, the request unit 63 of the mobile terminal 50a requests all devices other than the on-board apparatus 40 to mute (4). Specifically, the request unit 63 transmits a mute request to the mobile terminal 50b, which is a share destination other than the on-board apparatus 40, and performs volume output control using the volume setting unit 64 to set the volume to zero.

The request receiving unit 73 of the mobile terminal 50b receives a mute request from the mobile terminal 50a, and the volume setting unit 74 sets the volume of the speaker of own terminal to zero. The request receiving unit 73 of the on-board apparatus 40 does not receive the mute request from the mobile terminal 50a, the volume setting unit 74 does not mute, and the speaker 41 continues to output sound.

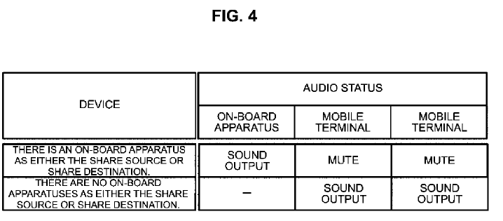

FIG. 4 is an explanatory diagram of sound control while sharing. If the on-board apparatus 40 is present as a share source or share destination, the on-board apparatus 40 outputs sound, and the other mobile terminals are set to mute. If the on-board apparatus 40 is not present in either the share source or the share destination, no sound is output from the on-board apparatus 40, and the plurality of mobile terminals individually output sounds.

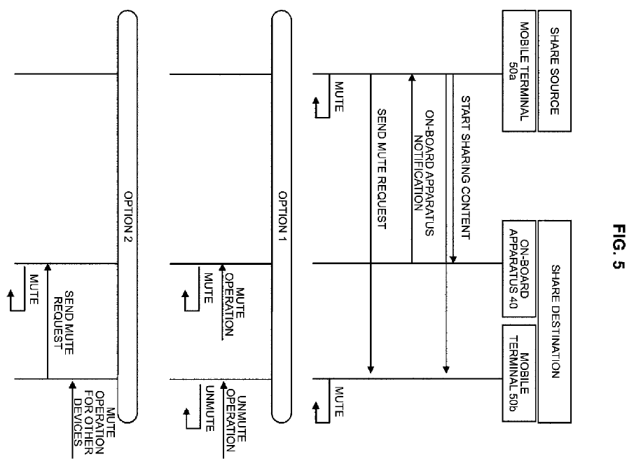

FIG. 5 is a sequence diagram of the operation of the terminal while sharing. The mobile terminal 50a, which is the share source, starts sharing content and transmits the content data to the share destination terminal. The share destination terminals are the on-board apparatus 40 and the mobile terminal 50b. The content data transmitted includes images and audio. The on-board apparatus 40 that has received the content data transmits, to the mobile terminal 50a, notification indicating that own terminal is the on-board apparatus. The mobile terminal 50a recognizes from the notification from the on-board apparatus 40 that the on-board apparatus is present in the shared group, and mutes the terminals other than the on-board apparatus 40. Specifically, the mobile terminal 50a transmits a mute request to the mobile terminal 50b and also sets own terminal to mute. The mobile terminal 50b receives the mute request and sets own terminal to mute.

As a first option, each terminal may be able to change own terminal audio output settings. For example, the on-board apparatus 40 may accept a mute operation and set own terminal to mute, and the mobile terminal 50b may accept an unmute operation and cancel muting of own terminal. In this option, a state that has been set based on a request from a share source can be overwritten by a direct operation performed on own terminal.

A second option may be to allow the settings to be changed for other terminals. For example, the mobile terminal 50b may accept a mute operation for the on-board apparatus 40, and transmit a mute request to the on-board apparatus 40, and the on-board apparatus 40 may set own terminal to mute. This option allows other terminals to override the state set based on request of the share source.

When sharing content, the image displayed on the control terminal 60 may be synchronized with the image displayed on the first terminal 70. Specifically, synchronous mode can be selected as the operation mode of the control terminal 60. In synchronous mode, for example, display of an image on the first terminal 70, which is the share destination, is synchronized with display of the image on the control terminal 60, which is the share source. In synchronous mode, there is little difference in the timing at which images are displayed between the share source and the share destination. Therefore, the timing of the audio output from the on-board apparatus 40 and the display on each terminal are substantially aligned.

If the control terminal 60 does not operate in synchronous mode despite having a synchronous mode function, the operator is understood to desire that a plurality of terminals individually output the shared content. Therefore, the control terminal 60 may be further provided with the monitoring unit 67 that monitors whether synchronous mode is being executed, and may be configured to request muting of terminals other than the on-board apparatus 40 under the condition that synchronous mode is being executed. The monitoring unit 67 determines whether synchronous mode is being executed in which the image displayed on the control terminal 60 is synchronized with the image displayed on the first terminal 70. When the monitoring unit 67 determines that synchronous mode is being executed, the request unit 63 requests the first terminal 70 or the control terminal 60 to mute in accordance with the determination by the first determination unit 61. When the monitoring unit 67 determines that synchronous mode is not being executed, the request unit 63 does not request the first terminal 70 or the control terminal 60 to mute.

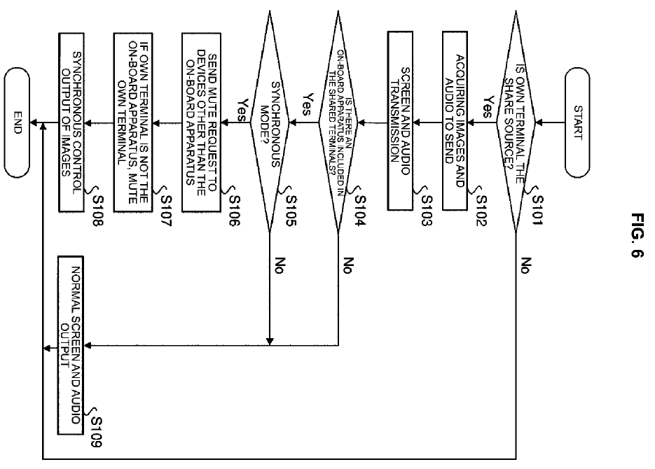

FIG. 6 is a flowchart depicting the processing procedure of a terminal having a synchronous mode. The terminal sequentially executes the following steps S101 to S109.

Step S101: own terminal determines whether or not own terminal is the share source. If not the share source (step S101; No), the process ends. If the own terminal is the share source (step S101; Yes), the process proceeds to step S102.

Step S102: the terminal acquires the image and audio to be transmitted. Thereafter, the process proceeds to Step S103. Step S103: the terminal transmits the image and audio to the share destination. Thereafter, the process proceeds to Step S104.

Step S104: the terminal determines whether or not an on-board apparatus is included as a shared terminal. If there is an on-board apparatus (step S104; Yes), the process proceeds to step S105. If there is no on-board apparatus (step S104; No), the process proceeds to step S109.

Step S105: the terminal determines whether or not own device is in synchronous mode. If synchronous mode is being executed (step S105; Yes), the process proceeds to step S106. If synchronous mode is not being executed (step S105; No), the process proceeds to step S109.

Step S106: the terminal transmits a mute request to everything other than the on-board apparatus. Thereafter, the process proceeds to Step S107. Step S107: If own terminal is not the on-board apparatus, own terminal is set to mute. Thereafter, the process proceeds to step S108.

In step S108, the terminal outputs the image while controlling synchronization. Thereafter, the process is terminated. Step S109: the terminal outputs image and sound in the normal manner, and the process ends.

As described above, a control terminal 60 is configured to control sound reproduced by a first terminal 70 in a vehicle, where the control terminal 60 includes: an audio transmission unit 65 that transmits to the first terminal 70, sound to be reproduced by the first terminal 70; a first determination unit 61 that determines whether the first terminal is capable of outputting sound from a speaker 41 mounted in the vehicle; and a request unit 63 that requests muting of the first terminal 70 in accordance with determination by the first determination unit 61; wherein if the first terminal 70 is capable of outputting sound from the speaker mounted in the vehicle, the request unit 63 causes sound to be reproduced by the first terminal 70 without requesting muting of the first terminal 70, and if the first terminal 70 is not capable of outputting sound from the speaker 41 mounted in the vehicle, the request unit 63 requests muting of the first terminal 70. According to this configuration and operation, the control terminal requests muting depending on the type of the first terminal, thereby enabling the sound of the same content to be shared by the occupants on the on-board speaker.

The control terminal further includes: a second determination unit 62 that determines whether the control terminal 60 is capable of outputting sound from the speaker mounted in the vehicle, wherein if the control terminal 60 is capable of outputting sound from the speaker 41 mounted in the vehicle and the first terminal 70 is not capable of outputting sound from the speaker 41 mounted in the vehicle, the request unit 63 does not request muting of the control terminal 60 and requests muting of the first terminal 70. According to this configuration and operation, when either the control terminal or the first terminal can cause a sound to be heard by all occupants via the on-board speaker, the terminals other than the one that can cause a sound to be heard by all occupants are muted. This allows occupants to share the same content on the on-board speaker.

If neither the first terminal 70 nor the control terminal 60 is capable of outputting sound from the speaker 41 mounted in the vehicle, the request unit 63 does not request muting of the first terminal 70 or the control terminal 60. According to this configuration and operation, when neither the control terminal nor the first terminal can cause sound to be heard by all occupants through the on-board speaker, sound can be output from each terminal.

An image transmission unit 66 that transmits an image generated by the control terminal 60 to the first terminal 70; and a monitoring unit 67 that determines whether a synchronous mode, in which an image displayed on the first terminal is synchronized with the image displayed on the control terminal, is being executed, wherein if the monitoring unit 67 determines that synchronous mode is being executed, the request unit 63 requests muting of the first terminal or the control terminal in accordance with determination by the first determination unit. According to this configuration and operation, when an image displayed on a terminal other than the control terminal is synchronized with the sound output from the vehicle's speakers, the sound output from the terminal other than the control terminal can be muted, thereby reducing the discomfort felt by occupants due to offset between the image and the sound.

The present invention is not limited to the abovementioned examples and includes various modified examples. For example, while the above-mentioned embodiment has been described in detail in order to describe the present invention in an easy-to-understand manner, the present invention is not necessarily limited to those with all the described configurations. Moreover, not only the deletion of such configurations, but also the replacement or addition of configurations is possible.

For example, in the above embodiment, a configuration in which a mute request is transmitted to devices other than the on-board apparatus upon receipt of a notification from the on-board apparatus was described as an example; however, whether the on-board apparatus is included in a shared group may be determined by another method.

In the above embodiment, the on-board apparatus 40 is described as an example of a terminal capable of outputting sound from the on-board speaker 41, and a configuration for determining whether or not the terminal is the on-board apparatus is described as an example, but the terminal capable of outputting sound from an on-board speaker 41 may be another terminal. In addition, any method can be used to determine whether or not sound can be output from the on-board speaker 41.

The control terminal 60 and the first terminal 70 have different roles when sharing content, and may be achieved by a single control program. In other words, of the terminals that execute the control program, the terminal that attempts to share content with another terminal operates as the control terminal 60, and the terminal that has content shared therewith from another terminal operates as the first terminal 70.

### DESCRIPTION OF REFERENCE NUMERALS

30. Vehicle, 40. On-board apparatus, 41. Speaker, 50. Mobile terminal, 60. Control terminal, 61. First determination unit, 62. Second determination unit, 63. Request unit, 64. Volume setting unit, 65. Audio transmission unit, 66. Image transmission unit, 67. Monitoring unit, 70. First terminal.

1. A control terminal configured to control sound reproduced by a first terminal in a vehicle, the control terminal comprising:
an audio transmission unit that transmits to the first terminal, sound to be reproduced by the first terminal;
a first determination unit that determines whether the first terminal is capable of outputting sound from a speaker mounted in the vehicle; and
a request unit that requests muting of the first terminal in accordance with determination by the first determination unit,
wherein when the first terminal is capable of outputting sound from the speaker mounted in the vehicle, the request unit causes sound to be reproduced by the first terminal without requesting muting of the first terminal, and when the first terminal is not capable of outputting sound from the speaker mounted in the vehicle, the request unit requests muting of the first terminal.

2. The control terminal according to claim 1, further comprising:
a second determination unit that determines whether the control terminal is capable of outputting sound from the speaker mounted in the vehicle,
wherein when the control terminal is capable of outputting sound from the speaker mounted in the vehicle and the first terminal is not capable of outputting sound from the speaker mounted in the vehicle, the request unit does not request muting of the control terminal and requests muting of the first terminal.

3. The control terminal according to claim 2, wherein when neither the first terminal nor the control terminal is capable of outputting sound from the speaker mounted in the vehicle, the request unit does not request muting of the first terminal or the control terminal.

4. The control terminal according to claim 1, further comprising:
an image transmission unit that transmits an image generated by the control terminal to the first terminal; and
a monitoring unit that determines whether a synchronous mode, in which an image displayed on the first terminal is synchronized with the image displayed on the control terminal, is being executed,
wherein when the monitoring unit determines that synchronous mode is being executed, the request unit requests muting of the first terminal or the control terminal in accordance with determination by the first determination unit.

5. A control method, comprising the steps of:
an audio transmission step in which a control terminal present in a vehicle transmits sound to be reproduced by a first terminal in the vehicle to the first terminal;
a first determination step of determining whether the first terminal is capable of outputting sound from a speaker mounted in the vehicle; and
a request step of requesting muting of the first terminal in accordance with a determination in the first determination step,
wherein the request step causes sound to be reproduced by the first terminal without requesting muting of the first terminal when the first terminal is capable of outputting sound from the speaker mounted in the vehicle, and requests muting of the first terminal when the first terminal is not capable of outputting sound from the speaker mounted in the vehicle.

6. A control program executed by a control terminal present in a vehicle, the control program causing the control terminal to perform:
an audio transmission step of transmitting, to a first terminal in the vehicle, sound to be reproduced by the first terminal;
a first determination step of determining whether the first terminal is capable of outputting sound from a speaker mounted in the vehicle; and
a request step of requesting muting of the first terminal in accordance with a determination in the first determination step,
wherein the request step causes sound to be reproduced by the first terminal without requesting muting of the first terminal when the first terminal is capable of outputting sound from the speaker mounted in the vehicle, and requests muting of the first terminal when the first terminal is not capable of outputting sound from the speaker mounted in the vehicle.
